(19) United States
(12) Patent Application Publication
(10) Pub. No.: US 2017/0011117 A1
(43) Pub. Date: Jan. 12, 2017

(54) Help Processing Method and Device Based on Semantic Recognition

(71) Applicant: Huawei Technologies Co., Ltd., Shenzhen (CN)

(72) Inventors: Qiang Jiang, Shenzhen (CN); Hang Li, Hong Kong (HK); Shan He, Shenzhen (CN)

(21) Appl. No.: 15/274,320

(22) Filed: Sep. 23, 2016

Related U.S. Application Data
(63) Continuation of application No. PCT/CN2015/075103, filed on Mar. 26, 2015.

(30) Foreign Application Priority Data
Mar. 26, 2014 (CN) 201410117710.2

(51) Int. Cl. G06F 17/30; G06F 17/21; G06F 17/27

(52) U.S. Cl. CPC G06F 17/30705; G06F 17/2785; G06F 17/274; G06F 17/218; G06F 17/278; G06F 17/30684; G06F 17/30651

(57) ABSTRACT

A help processing method and device based on semantic recognition are presented. The method includes receiving, by user equipment, a search request entered by a user, where the search request includes information about a problem statement described in a natural language; performing semantic recognition processing on the information about the problem statement, to obtain information about a search intention of the user; and searching a database using the information about the search intention as a search term, to obtain help content needed by the user.

### CROSS-REFERENCE TO RELATED APPLICATIONS

This application is a continuation of International Application No. PCT/CN2015/075103, filed on Mar. 26, 2015, which claims priority to Chinese Patent Application No. 201410117710.2, filed on Mar. 26, 2014, both of which are hereby incorporated by reference in their entireties.

### TECHNICAL FIELD

The present disclosure relates to the field of communications technologies, and in particular, to a help processing method and device based on semantic recognition.

### BACKGROUND

With rapid development of intelligent terminal devices, the terminal devices have richer functions and larger user groups. However, functions are more complex, which raises a use threshold of users, lowers experience effects of users, and affects evaluation of users on the terminal devices. Currently, most terminal vendors provide terminal devices with corresponding help manuals, and the help manuals are extremely rich in content and have a relatively wide coverage.

Because a help manual of an intelligent terminal device has excessive entries and a deep menu hierarchy, which is inconvenient for a user to use the help manual, an operator puts forward an intelligent help system based on a keyword, that is, by entering a search keyword to a user interface of the intelligent help system, the user may rapidly locate content corresponding to the keyword after tapping Search.

However, in the intelligent help system based on a keyword, a system developer needs to tag some objects in advance, so as to facilitate search of a user. However, tagging is of great subjectivity. For a same object, different persons may absolutely have different understanding and tag the same object with different keywords, and therefore the keywords for tagging cannot absolutely accurately and objectively reflect a technical problem that a user intends to search for, and consequently, the intelligent help system cannot well reflect a true intention of the user either, and cannot accurately provide the user with content that is searched for either, which leads to low use efficiency of the system.

### SUMMARY

The present disclosure provides a help processing method and device based on semantic recognition, so as to resolve a problem in the prior art that an intelligent help system cannot well reflect a true intention of a user and cannot accurately provide the user with content that is searched for, which leads to low use efficiency of the system.

A first aspect of the present disclosure provides a help processing method based on semantic recognition, including receiving, by user equipment, a search request entered by a user, where the search request includes information about a problem statement described in a natural language; performing semantic recognition processing on the information about the problem statement, to obtain information about a search intention of the user; and searching a database using the information about the search intention as a search term, to obtain help content needed by the user.

In a first possible implementation manner of the first aspect, the performing semantic recognition processing on the information about the problem statement, to obtain information about a search intention of the user includes sending the information about the problem statement to a network server, so that the network server performs semantic recognition processing on the information about the problem statement, to obtain the information about the search intention; and receiving the information, which is fed back by the network server, about the search intention.

With reference to the first aspect or the first possible implementation manner of the first aspect, in a second possible implementation manner of the first aspect, the searching a database using the information about the search intention as a search term, to obtain help content needed by the user includes searching, using the information about the search intention as the search term, a help database pre-stored in user equipment, to obtain the help content needed by the user, where help content is pre-stored in the help database; or sending the search term to the network server, so that the network server searches a network database, to obtain the help content needed by the user, and receiving the help content that is needed by the user and that is fed back by the network server.

With reference to the first aspect or the first possible implementation manner of the first aspect, in a third possible implementation manner of the first aspect, the performing semantic recognition processing on the information about the problem statement, to obtain information about a search intention includes performing word segmentation processing on the information about the problem statement, to obtain a preprocessed search term; performing part-of-speech tagging and entity title identification processing on the preprocessed search term; and performing matching between the preprocessed search term after the part-of-speech tagging and entity title identification processing and a pre-stored semantic lexicon, and determining the information about the search intention of the user.

With reference to the first aspect or any one of the first to third possible implementation manners of the first aspect, in a fourth possible implementation manner of the first aspect, the searching a database using the information about the search intention as a search term, to obtain help content needed by the user includes determining a help service category according to the information about the search intention; and searching, using the information about the search intention as a keyword, a database corresponding to the help service category, to obtain the help content needed by the user.

With reference to the fourth possible implementation manner of the first aspect, in a fifth possible implementation manner of the first aspect, the determining a help service category according to the information about the search intention includes performing machine learning on the information about the search intention, and determining the help service category; or performing a search using the information about the search intention as an index, to obtain the help service category corresponding to the information about the search intention.

With reference to the fifth possible implementation manner of the first aspect, in a sixth possible implementation manner of the first aspect, the performing machine learning on the information about the search intention, and determining the help service category includes comparing a word included in the information about the search intention with words stored in a pre-established help service categorization base, and removing a word not related to the help service category or a redundant word; performing standardization processing on a word remaining in the information about the search intention, to obtain a standard search term of the help service categorization; and categorizing the standard search term using a classification algorithm, and determining the help service category.

With reference to the sixth possible implementation manner of the first aspect, in a seventh possible implementation manner of the first aspect, the performing standardization processing on a word remaining in the information about the search intention, to obtain a standard search term of the help service categorization includes comparing a word needed for the help service categorization with a synonym list stored in a pre-established standard lexicon, to obtain a corresponding standard search term of the help service categorization.

With reference to the fifth possible implementation manner of the first aspect, in an eighth possible implementation manner of the first aspect, the performing a search using the information about the search intention as an index, to obtain the help service category corresponding to the information about the search intention includes performing matching according to a word included in the information about the search intention and index words stored in all types of pre-established help service bases, and determining the help service category.

With reference to any one of the fourth to eighth possible implementation manners of the first aspect, in a ninth possible implementation manner of the first aspect, the help service category is a user equipment repair or query category, and correspondingly, searching the help database corresponding to the help service category according to the information about the search intention, to acquire the help content needed by the user includes searching a device status information base corresponding to the user equipment repair or query category, and acquiring a status detection report matching the information about the search intention; determining, according to the status detection report, whether a working state of the user equipment is abnormal; and if the working state of the user equipment is abnormal, acquiring an anomaly repair program according to an anomaly state in the status detection report, or generating an anomaly repair program according to an anomaly state in the status detection report, or acquiring and generating an anomaly repair program according to an anomaly state in the status detection report.

With reference to the ninth possible implementation manner of the first aspect, in a tenth possible implementation manner of the first aspect, the anomaly state includes device setting anomaly information; and correspondingly, the acquiring an anomaly repair program according to an anomaly state in the status detection report, the generating an anomaly repair program according to an anomaly state in the status detection report, or the acquiring and generating an anomaly repair program according to an anomaly state in the status detection report includes acquiring a normal setting process, or generating a normal setting process, or acquiring and generating a normal setting process according to the device setting anomaly information; and correspondingly, the method further includes performing normal setting processing according to the normal setting process.

With reference to the ninth possible implementation manner of the first aspect, in an eleventh possible implementation manner of the first aspect, the anomaly state includes device hardware fault information; and correspondingly, the acquiring an anomaly repair program according to an anomaly state in the status detection report, the generating an anomaly repair program according to an anomaly state in the status detection report, or the acquiring and generating an anomaly repair program according to an anomaly state in the status detection report includes acquiring a hardware anomaly repair program, or generating a hardware anomaly repair program, or acquiring and generating a hardware anomaly repair program according to the device hardware fault information; and correspondingly, the method further includes performing hardware fault repair processing according to the hardware anomaly repair program.

With reference to the ninth possible implementation manner of the first aspect, in a twelfth possible implementation manner of the first aspect, the anomaly state includes device software anomaly information; and correspondingly, the acquiring an anomaly repair program according to an anomaly state in the status detection report, the generating an anomaly repair program according to an anomaly state in the status detection report, or the acquiring and generating an anomaly repair program according to an anomaly state in the status detection report includes acquiring a software anomaly repair program, or generating a software anomaly repair program, or acquiring and generating a software anomaly repair program according to the device software anomaly information; and correspondingly, the method further includes performing software fault repair processing according to the software anomaly repair program.

With reference to any one of the fourth to eighth possible implementation manners of the first aspect, in a thirteenth possible implementation manner of the first aspect, the help service category is an operation inquiry category; and correspondingly, searching the help database corresponding to the help service category according to the information about the search intention, to acquire the help content needed by the user includes searching a database corresponding to the operation inquiry category, and acquiring help knowledge information matching the information about the search intention; or generating operation step guiding information according to the help knowledge information.

A second aspect of the present disclosure provides a help processing device based on semantic recognition, including a receiving module configured to receive a search request entered by a user, where the search request includes information about a problem statement described in a natural language; a semantic module configured to perform semantic recognition processing on the information about the problem statement, to obtain information about a search intention of the user; and a search module configured to search a database using the information about the search intention as a search term, to obtain help content needed by the user.

In a first possible implementation manner of the second aspect, the semantic module is configured to send the information about the problem statement to a network server, so that the network server performs semantic recognition processing on the information about the problem statement, to obtain the information about the search intention; and correspondingly, the receiving module is configured to receive the information, which is fed back by the network server, about the search intention.

With reference to the second aspect or the first possible implementation manner of the second aspect, in a second possible implementation manner of the second aspect, the search module is configured to search, using the information about the search intention as the search term, a help database pre-stored in user equipment, to obtain the help content needed by the user, where help content is pre-stored in the help database; or send the search term to the network server, so that the network server searches a network database, to obtain the help content needed by the user, and receive the help content that is needed by the user and that is fed back by the network server.

With reference to the second aspect or the first possible implementation manner of the second aspect, in a third possible implementation manner of the second aspect, the semantic module is configured to perform word segmentation processing on the information about the problem statement, to obtain a preprocessed search term; perform part-of-speech tagging and entity title identification processing on the preprocessed search term; and perform matching between the preprocessed search term after the part-of-speech tagging and entity title identification processing and a pre-stored semantic lexicon, and determine the information about the search intention of the user.

With reference to the second aspect or any one of the first to third possible implementation manners of the second aspect, in a fourth possible implementation manner of the second aspect, the search module is configured to determine a help service category according to the information about the search intention; and search, using the information about the search intention as a keyword, a database corresponding to the help service category, to obtain the help content needed by the user.

With reference to the fourth possible implementation manner of the second aspect, in a fifth possible implementation manner of the second aspect, the search module is configured to perform machine learning on the information about the search intention, and determine the help service category; or perform a search using the information about the search intention as an index, to obtain the help service category corresponding to the information about the search intention.

With reference to the fifth possible implementation manner of the second aspect, in a sixth possible implementation manner of the second aspect, the search module is configured to compare a word included in the information about the search intention with words stored in a pre-established help service categorization base, and remove a word not related to the help service category or a redundant word; perform standardization processing on a word remaining in the information about the search intention, to obtain a standard search term of the help service categorization; and categorize the standard search term using a classification algorithm, and determine the help service category.

With reference to the sixth possible implementation manner of the second aspect, in a seventh possible implementation manner of the second aspect, the search module is configured to compare a word needed for the help service categorization with a synonym list stored in a pre-established standard lexicon, to obtain a corresponding standard search term of the help service categorization.

With reference to the fifth possible implementation manner of the second aspect, in an eighth possible implementation manner of the second aspect, the search module is configured to perform matching according to a word included in the information about the search intention and index words stored in all types of pre-established help service bases, and determine the help service category.

With reference to any one of the fourth to eighth possible implementation manners of the second aspect, in a ninth possible implementation manner of the second aspect, the help service category is a user equipment repair or query category, and correspondingly, the search module is configured to search a device status information base corresponding to the user equipment repair or query category, and acquire a status detection report matching the information about the search intention; determine, according to the status detection report, whether a working state of the user equipment is abnormal; and if the working state of the user equipment is abnormal, acquire an anomaly repair program according to an anomaly state in the status detection report, or generate an anomaly repair program according to an anomaly state in the status detection report, or acquire and generate an anomaly repair program according to an anomaly state in the status detection report.

With reference to the ninth possible implementation manner of the second aspect, in a tenth possible implementation manner of the second aspect, the anomaly state includes device setting anomaly information; and correspondingly, the search module is configured to acquire a normal setting process, or generate a normal setting process, or acquire and generate a normal setting process according to the device setting anomaly information; and correspondingly, the device further includes a setting module configured to perform normal setting processing according to the normal setting process.

With reference to the ninth possible implementation manner of the second aspect, in an eleventh possible implementation manner of the second aspect, the anomaly state includes device hardware fault information; and correspondingly, the search module is configured to acquire a hardware anomaly repair program, or generate a hardware anomaly repair program, or acquire and generate a hardware anomaly repair program according to the device hardware fault information; and correspondingly, the device further includes a repair module configured to perform hardware fault repair processing according to the hardware anomaly repair program.

With reference to the ninth possible implementation manner of the second aspect, in a twelfth possible implementation manner of the second aspect, the anomaly state includes device software anomaly information; and correspondingly, the search module is configured to acquire a software anomaly repair program, or generate a software anomaly repair program, or acquire and generate a software anomaly repair program according to the device software anomaly information; and correspondingly, the repair module is further configured to perform software fault repair processing according to the software anomaly repair program.

With reference to any one of the fourth to eighth possible implementation manners of the second aspect, in a thirteenth possible implementation manner of the second aspect, the help service category is an operation inquiry category; and correspondingly, the search module is configured to search a database corresponding to the operation inquiry category, and acquire help knowledge information matching the information about the search intention; or generate operation step guiding information according to the help knowledge information.

According to the present disclosure, semantic understanding is performed on a problem statement that is described by a user in a natural language, to obtain a search intention closer to a true idea of the user; and then, help content needed by the user is acquired according to information about the search intention, and a problem that the user intends to search for can be accurately located, so that an answer to the problem can be found rapidly, and search efficiency is relatively high.

### BRIEF DESCRIPTION OF DRAWINGS

FIG. 1 is a schematic flowchart of Embodiment 1 of a help processing method based on semantic recognition according to the present disclosure;

FIG. 2 is a schematic flowchart of Embodiment 2 of a help processing method based on semantic recognition according to the present disclosure;

FIG. 3 is a schematic flowchart of Embodiment 3 of a help processing method based on semantic recognition according to the present disclosure;

FIG. 4 is a schematic flowchart of Embodiment 4 of a help processing method based on semantic recognition according to the present disclosure;

FIG. 5 is a schematic structural diagram of Embodiment 1 of a help processing device based on semantic recognition according to the present disclosure;

FIG. 6 is a schematic structural diagram of Embodiment 2 of a help processing device based on semantic recognition according to the present disclosure; and

FIG. 7 is a schematic structural diagram of Embodiment 3 of a help processing device based on semantic recognition according to the present disclosure.

### DESCRIPTION OF EMBODIMENTS

To make the objectives, technical solutions, and advantages of the present disclosure clearer, the following clearly describes the technical solutions in the present disclosure with reference to the accompanying drawings in the present disclosure. The described embodiments are a part rather than all of the embodiments of the present disclosure. All other embodiments obtained by a person of ordinary skill in the art based on the embodiments of the present disclosure without creative efforts shall fall within the protection scope of the present disclosure.

### Embodiment 1

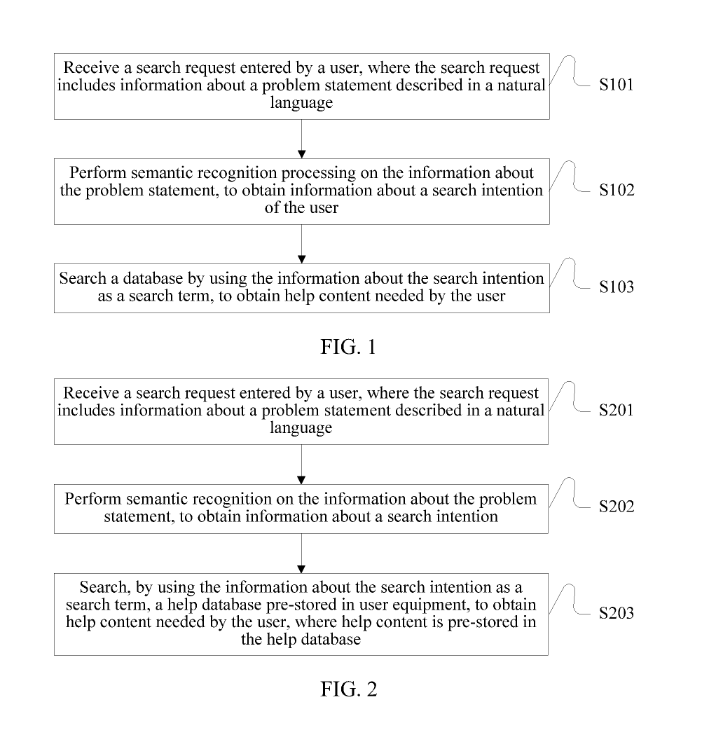

As shown in FIG. 1, FIG. 1 is a schematic flowchart of Embodiment 1 of a help processing method based on semantic recognition according to the present disclosure, which includes the following steps.

Step S101: Receive a search request entered by a user, where the search request includes information about a problem statement described in a natural language.

It should be noted that, this embodiment may be executed by user equipment, for example, may be a mobile terminal device such as a notebook computer, a smartphone, an iPad, or an iPhone, or may be a fixed terminal device such as a desktop computer or a digital television terminal, which is not limited herein. In addition, a user may enter a search request in a text or voice form.

Step S102: Perform semantic recognition processing on the information about the problem statement, to obtain information about a search intention of the user.

A manner of obtaining information about a search intention may be that the user equipment performs semantic recognition on the information about the problem statement to obtain the information about the search intention or may be that the user equipment sends the information about the problem statement to a network-side server, and the network-side server performs, on a network side, semantic recognition on the received information about the problem statement to obtain the information about the search intention. A method for performing semantic recognition processing on the information about the problem statement may be, for example, performing word segmentation processing on the information about the problem statement, to obtain a preprocessed search term; then performing part-of-speech tagging and entity title identification processing on the obtained preprocessed search term; and performing matching between the preprocessed search term after the part-of-speech tagging and entity title identification processing and a pre-stored semantic lexicon, and determining the information about the search intention of the user.

In addition, it should be noted that, when the foregoing problem statement is a problem statement in a voice form, before semantic recognition is performed on the information about the problem statement, the information about the problem statement in a voice form needs to be converted into the information about the problem statement in a text form, so as to perform subsequent semantic recognition processing on the information about the problem statement.

Step S103: Search a database using the information about the search intention as a search term, to obtain help content needed by the user.

A manner of acquiring, by the user equipment according to the information about the search intention, help content needed by the user may be that the user equipment searches a help database according to the obtained information about the search intention of the user, to acquire the help content needed by the user from the help database. The help database is a help database in the user equipment, and the user equipment may provide the help content for the user in a text form, a voice form, an animation form, or an instruction execution result form. Alternatively, may be that the user equipment sends the information about the search intention to the network-side server, and the network-side server searches a help database according to the information about the search intention, to obtain help content needed by the user, and feeds the found help content back to the user equipment. The help database is a help database on a network side, and a network server may feed the help content back to the user in a text form, a voice form, an animation form, or an instruction execution result form.

According to this embodiment, semantic understanding is performed on a problem statement that is described by a user in a natural language, to obtain a search intention closer to a true idea of the user, and then, help content needed by the user is acquired according to information about the search intention. In this embodiment, a problem that the user intends to search for can be accurately located, so that an answer to the problem can be found rapidly, and search efficiency is relatively high.

### Embodiment 2

As shown in FIG. 2, FIG. 2 is a schematic flowchart of Embodiment 2 of a help processing method based on semantic recognition according to the present disclosure, which includes the following steps.

Step S201: Receive a search request entered by a user, where the search request includes information about a problem statement described in a natural language.

It should be noted that, the foregoing user equipment may be a mobile terminal device such as a notebook computer, a smartphone, an iPad, or an iPhone, or may be a fixed terminal device such as a desktop computer or a digital television terminal, which is not limited herein. In addition, a user may enter a search request in a text or voice form.

Step S202: Perform semantic recognition on the information about the problem statement, to obtain information about a search intention.

Word segmentation processing may be performed on the information about the problem statement, to obtain a preprocessed search term; then part-of-speech tagging and entity title identification processing is performed on the obtained preprocessed search term; and matching between the preprocessed search term after the part-of-speech tagging and entity title identification processing and a pre-stored semantic lexicon is performed, to obtain the information about the search intention of the user.

In addition, it should be noted that, when the foregoing problem statement is a problem statement in a voice form, before semantic recognition is performed on the information about the problem statement, the information about the problem statement in a voice form needs to be converted into the information about the problem statement in a text form, so as to perform subsequent semantic recognition processing on the information about the problem statement.

Step S203: Search, using the information about the search intention as a search term, a help database pre-stored in user equipment, to obtain help content needed by the user, where help content is pre-stored in the help database.

The user equipment searches, according to the obtained information about the search intention, a help database pre-stored in a user equipment system, to acquire help content needed by the user from the help database; or, the user equipment sends the information about the search intention to a network server, the network server searches a network database of a network according to the information about the search intention, to obtain help content needed by the user, and the network server feeds the help content back to the user equipment. The help content may be in a text format, a voice format, an animation format, or an instruction format.

In addition, S202 and S203 in this embodiment may be further implemented using the following method: the user equipment sends the information about the problem statement to a network server, so that the network server performs, on a network side, semantic recognition on the received information about the problem statement, to obtain information about a search intention of the user. After obtaining the information about the search intention by performing the semantic recognition on the information about the problem statement, the network server searches a network database of a network according to the information about the search intention, to obtain help content needed by the user and feeds the help content back to the user equipment, or, after obtaining the information about the search intention by performing the semantic recognition on the information about the problem statement, the network server feeds the information about the search intention back to the user equipment, and after receiving the information about the search intention, the user equipment searches a help database according to the information about the search intention, to acquire help content needed by the user. The help content may be in a text format, a voice format, an animation format, or an instruction format.

According to this embodiment, user equipment sends a problem statement, which is described by a user in a natural language, of the user to a network server; semantic understanding is performed, on a network side, on the problem statement that is described by the user in the natural language, to obtain a search intention closer to a true idea of the user; and help content needed by the user is acquired from a network database on a network side according to information about a search intention, or information about a search intention is sent to the user equipment, so that the user equipment acquires, according to the information about the search intention, help content needed by the user. In this embodiment, a problem that the user intends to search for can be accurately located, so that an answer to the problem can be found rapidly, and search efficiency is relatively high.

### Embodiment 3

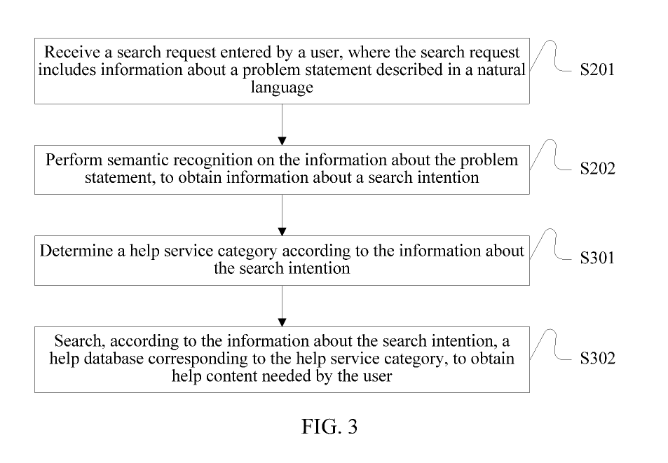

As shown in FIG. 3, FIG. 3 is a schematic flowchart of Embodiment 3 of a help processing method based on semantic recognition according to the present disclosure. In this embodiment, based on Embodiment 2, the step of searching a database using the information about the search intention as a search term, to obtain help content needed by the user is further optimized. The following steps are included.

Step S301: Determine a help service category according to the information about the search intention.

Machine learning may be performed on the information about the search intention in a machine learning manner to determine a help service category; or a help service category may be determined in a search index manner, for example, the help service category corresponding to the information about the search intention is obtained by means of a search using the information about the search intention as an index. When machine learning is performed on the information about the search intention in the machine learning manner to determine a help service category, a word included in the information about the search intention is first compared with words stored in a pre-established help service categorization base, and a word not related to the help service category or a redundant word is removed; standardization processing is then performed on a word remaining in the information about the search intention, that is, a word needed for the help service categorization is compared with a synonym list stored in a pre-established standard lexicon, to obtain a corresponding standard search term of the help service categorization; and finally the standard search term is categorized using a classification algorithm, and the help service category is determined, where the used classification algorithm may be a decision tree classification algorithm, a Bayes classification algorithm, an artificial neural network classification algorithm, a K-nearest neighbor classification algorithm, a Support Vector Machine classification algorithm, an association-rule based classification algorithm, and an ensemble learning classification algorithm. When a search is performed using the information about the search intention as an index, to obtain the help service category corresponding to the information about the search intention, matching is performed according to a word included in the information about the search intention and index words stored in all types of pre-established help service bases, and the help service category is determined.

Step S302: Search, using the information about the search intention as a keyword, a database corresponding to the help service category, to obtain the help content needed by the user.

When it is determined that the help service category is a user equipment repair or query category, a device status information base corresponding to the user equipment repair or query category is searched, and a status detection report matching the information about the search intention is acquired. It is determined, according to the status detection report, whether a working state of the user equipment is abnormal; and if the working state of the user equipment is abnormal, an anomaly repair program is acquired, an anomaly repair program is generated, or an anomaly repair program is acquired and generated according to an anomaly state in the status detection report. For example, when the anomaly state is device setting anomaly information, a normal setting process is acquired, a normal setting process is generated, or a normal setting process is acquired and generated according to the device setting anomaly information, and the user equipment performs normal setting processing according to a normal setting process. The setting anomaly information includes but is not limited to a call, a short message service message, a language and an input method, WiFi, Bluetooth, a mobile network, a voice, display, storage, a battery, an application program, security, permission, time and a date. A form of returning a processing result includes but is not limited to text (TXT), extensible markup language (XML), JavaScript object notation (JSON), and hypertext markup language (HTML). When the anomaly state is device hardware fault information, a hardware anomaly repair program is acquired, a hardware anomaly repair program is generated, or a hardware anomaly repair program is acquired and generated according to the device hardware fault information, and the user equipment performs hardware fault repair processing according to the hardware anomaly repair program, where the device hardware fault information includes but is not limited to network information (for example, includes but is not limited to wireless network information, Bluetooth, and a mobile network), date and clock information (is, for example, but is not limited to a date, time, and a time zone), location information (is, for example, but is not limited to global positioning system (GPS), a country, and a city), and information generated by a sensor (is, for example, but is not limited to information such as an acceleration, a magnetic force, a direction, a gyroscope, light sensing, a pressure, a temperature, facial sensing, a gravity, and a rotating vector), and a form of a detection report thereof includes but is not limited to application program interface (API), TXT, XML, JSON, and HTML. When the anomaly state is device software anomaly information, a software anomaly repair program is acquired or generated, a software anomaly repair program is generated, or a software anomaly repair program is acquired and generated according to the device software anomaly information, and the user equipment performs software fault repair processing according to the software anomaly repair program. A software anomaly detection entry includes but is not limited to an operating system and running software, process, a service state, and an event and provided data, and a form of a detection report thereof includes but is not limited to API, TXT, XML, JSON, and HTML. When it is determined that the help service category is an operation inquiry category, a database corresponding to the operation inquiry category is searched, and help knowledge information matching the information about the search intention is acquired; or operation step guiding information is generated according to the help knowledge information.

According to this embodiment, semantic understanding is performed on a problem statement that is described by a user in a natural language, to obtain a search intention closer to a true idea of the user; and according to the search intention, not only a fault problem of user equipment can be accurately located to complete fault repair, but also a problem that the user intends to search for can be accurately located, so that an answer to the problem can be found rapidly, and search efficiency is relatively high.

The following describes the present disclosure in detail using a specific embodiment.

### Embodiment 4

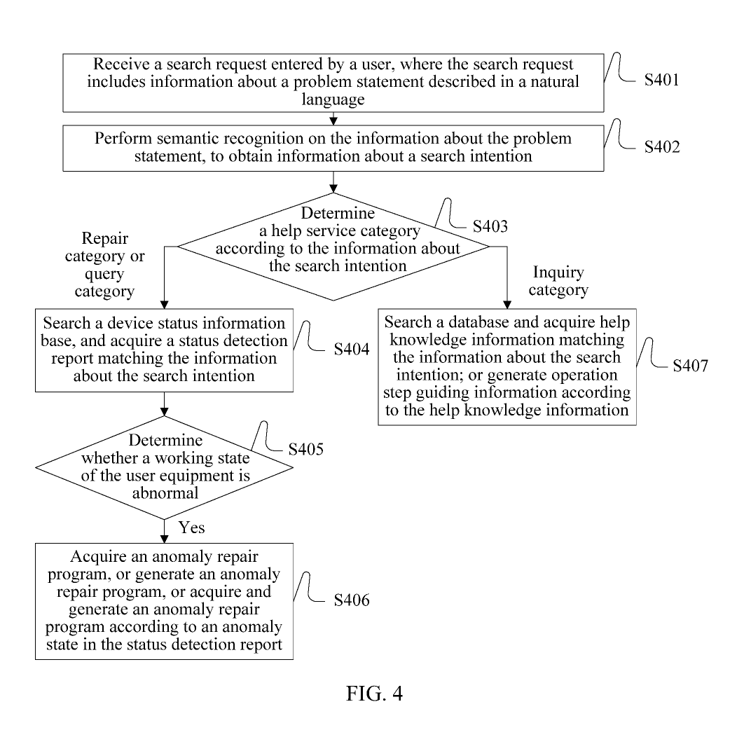

As shown in FIG. 4, FIG. 4 is a schematic flowchart of Embodiment 4 of a help processing method based on semantic recognition according to the present disclosure, which includes the following steps.

Step S401: Receive a search request entered by a user, where the search request includes information about a problem statement described in a natural language.

A user may enter a search request in a text or voice form, and when the foregoing problem statement is a problem statement in a voice form, before semantic recognition is performed on the information about the problem statement, the information about the problem statement in a voice form needs to be converted into the information about the problem statement in a text form, so as to perform subsequent semantic recognition processing on the information about the problem statement.

Step S402: Perform semantic recognition on the information about the problem statement, to obtain information about a search intention.

A manner of obtaining information about a search intention may be that the user equipment performs semantic recognition on the information about the problem statement to obtain the information about the search intention or may be that the user equipment sends the information about the problem statement to a network-side server, and the network-side server performs, on a network side, semantic recognition on the received information about the problem statement to obtain the information about the search intention. A method for performing semantic recognition processing on the information about the problem statement may be, for example, performing word segmentation processing on the information about the problem statement, to obtain a preprocessed search term; then performing part-of-speech tagging and entity title identification processing on the obtained preprocessed search term; and performing matching between the preprocessed search term after the part-of-speech tagging and entity title identification processing and a pre-stored semantic lexicon, and determining the information about the search intention of the user.

Step S403: Determine a help service category according to the information about the search intention.

Machine learning may be performed on the information about the search intention in a machine learning manner to determine a help service category; or a help service category may be determined in a search index manner, for example, the help service category corresponding to the information about the search intention is obtained by means of a search using the information about the search intention as an index. When machine learning is performed on the information about the search intention in the machine learning manner to determine a help service category, a word included in the information about the search intention is first compared with words stored in a pre-established help service categorization base, and a word not related to the help service category or a redundant word is removed; standardization processing is then performed on a word remaining in the information about the search intention, that is, a word needed for the help service categorization is compared with a synonym list stored in a pre-established standard lexicon, to obtain a corresponding standard search term of the help service categorization; and finally the standard search term is categorized using a classification algorithm, and the help service category is determined, where the used classification algorithm may be a decision tree classification algorithm, a Bayes classification algorithm, an artificial neural network classification algorithm, a K-nearest neighbor classification algorithm, a Support Vector Machine classification algorithm, an association-rule based classification algorithm, and an ensemble learning classification algorithm. When a search is performed using the information about the search intention as an index, to obtain the help service category corresponding to the information about the search intention, matching is performed according to a word included in the information about the search intention and index words stored in all types of pre-established help service bases, and the help service category is determined. When it is determined that the help service category is a repair category or a query category, step S404 to step S406 are performed; or when it is determined that the help service category is an inquiry category, step S407 is performed.

Step S404: Search a device status information base, and acquire a status detection report matching the information about the search intention.

Step S405: Determine whether a working state of the user equipment is abnormal.

A status detection report of the user equipment determines whether the working state is abnormal, and if yes, step S406 is performed.

Step S406: Acquire an anomaly repair program, or generate an anomaly repair program, or acquire and generate an anomaly repair program according to an anomaly state in the status detection report.

For example, when the anomaly state is device setting anomaly information, an anomaly repair program is acquired, an anomaly repair program is generated, or an anomaly repair program is acquired and generated according to the device setting anomaly information, and the user equipment performs normal setting processing according to a normal setting process, where the setting anomaly information includes but is not limited to a call, a short message service message, a language and an input method, WiFi, Bluetooth, a mobile network, a voice, display, storage, a battery, an application program, security, permission, time and a date. A form of returning a processing result includes but is not limited to TXT, XML, JSON, and HTML. When the anomaly state is device hardware fault information, a hardware anomaly repair program is acquired, a hardware anomaly repair program is generated, or a hardware anomaly repair program is acquired and generated according to the device hardware fault information, and the user equipment performs hardware fault repair processing according to the hardware anomaly repair program. The device hardware fault information includes but is not limited to network information (for example, includes but is not limited to wireless network information, Bluetooth®, and a mobile network), date and clock information (is, for example, but is not limited to a date, time, and a time zone), location information (is, for example, but is not limited to GPS, a country, and a city), and information generated by a sensor (is, for example, but is not limited to information such as an acceleration, a magnetic force, a direction, a gyroscope, light sensing, a pressure, a temperature, facial sensing, a gravity, and a rotating vector), and a form of a detection report thereof includes but is not limited to API, TXT, XML, JSON, and HTML. When the anomaly state is device software anomaly information, a software anomaly repair program is acquired, a software anomaly repair program is generated, or a software anomaly repair program is acquired and generated according to the device software anomaly information, and the user equipment performs software fault repair processing according to the software anomaly repair program. A software anomaly detection entry includes but is not limited to an operating system and running software, process, a service state, and an event and provided data, and a form of a detection report thereof includes but is not limited to API, TXT, XML, JSON, and HTML.

Step S407: Search a database and acquire help information matching the information about the search intention; or generate operation step guiding information according to the help information.

### Embodiment 5

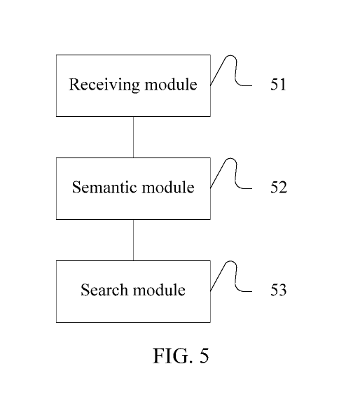

As shown in FIG. 5, FIG. 5 is a schematic structural diagram of Embodiment 1 of a help processing device based on semantic recognition according to the present disclosure, which includes a receiving module 51, a semantic module 52, and a search module 53.

The receiving module 51 is configured to receive a search request entered by a user, where the search request includes information about a problem statement described in a natural language.

The semantic module 52 is configured to perform semantic recognition processing on the information about the problem statement, to obtain information about a search intention of the user.

The search module 53 is configured to search a database using the information about the search intention as a search term, to obtain help content needed by the user.

The device described in this embodiment is configured to perform the method steps described in Embodiment 1. A technical principle and generated technical effect of the device are similar to those of the method steps described in Embodiment 1 and are not described herein again.

### Embodiment 6

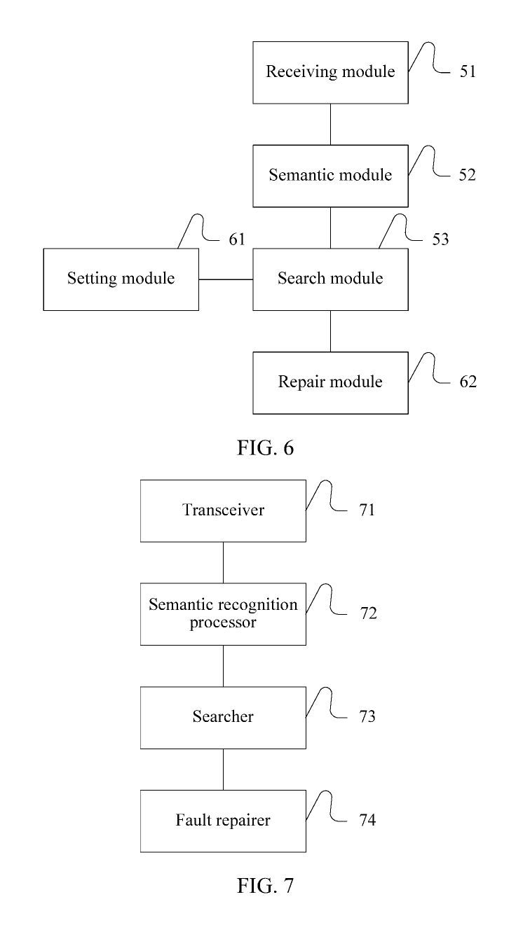

As shown in FIG. 6, FIG. 6 is a schematic structural diagram of Embodiment 2 of a help processing device based on semantic recognition according to the present disclosure. In addition to including the receiving module 51, the semantic module 52, and the search module 53 in Embodiment 5, in this embodiment, a setting module 61 and a repair module 62 are further included.

Further, the semantic module 52 is configured to send the information about the problem statement to a network server, so that the network server performs semantic recognition processing on the information about the problem statement, to obtain the information about the search intention; and correspondingly, the receiving module 51 is configured to receive the information, which is fed back by the network server, about the search intention.

Further, the search module 53 is configured to search, using the information about the search intention as the search term, a help database pre-stored in user equipment, to obtain the help content needed by the user, where help content is pre-stored in the help database; or send the search term to the network server, so that the network server searches a network database, to obtain the help content needed by the user, and receive the help content that is needed by the user and that is fed back by the network server.

Further, the semantic module 52 is configured to perform word segmentation processing on the information about the problem statement, to obtain a preprocessed search term; perform part-of-speech tagging and entity title identification processing on the preprocessed search term; and perform matching between the preprocessed search term after the part-of-speech tagging and entity title identification processing and a pre-stored semantic lexicon, and determine the information about the search intention of the user.

Further, the search module 53 is configured to determine a help service category according to the information about the search intention; and search, using the information about the search intention as a keyword, a database corresponding to the help service category, to obtain the help content needed by the user.

Further, the search module 53 is configured to perform machine learning on the information about the search intention, and determine the help service category; or perform a search using the information about the search intention as an index, to obtain the help service category corresponding to the information about the search intention.

Further, the search module 53 is configured to compare a word included in the information about the search intention with words stored in a pre-established help service categorization base, and remove a word not related to the help service category or a redundant word; perform standardization processing on a word remaining in the information about the search intention, to obtain a standard search term of the help service categorization; and categorize the standard search term using a classification algorithm, and determine the help service category.

Further, the search module 53 is configured to compare a word needed for the help service categorization with a synonym list stored in a pre-established standard lexicon, to obtain a corresponding standard search term of the help service categorization.

Further, the search module 53 is configured to perform matching according to a word included in the information about the search intention and index words stored in all types of pre-established help service bases, and determine the help service category.

Further, the help service category is a user equipment repair or query category, and correspondingly, the search module 53 is configured to search a device status information base corresponding to the user equipment repair or query category, and acquire a status detection report matching the information about the search intention; determine, according to the status detection report, whether a working state of the user equipment is abnormal; and if the working state of the user equipment is abnormal, acquire an anomaly repair program according to an anomaly state in the status detection report, or generate an anomaly repair program according to an anomaly state in the status detection report, or acquire and generate an anomaly repair program according to an anomaly state in the status detection report.

Further, the anomaly state includes device setting anomaly information; and correspondingly, the search module 53 is configured to acquire a normal setting process, or generate a normal setting process, or acquire and generate a normal setting process according to the device setting anomaly information; and correspondingly, the device further includes the setting module 61 configured to perform normal setting processing according to the normal setting process.

Further, the anomaly state includes device hardware fault information; and correspondingly, the search module 53 is configured to acquire a hardware anomaly repair program, or generate a hardware anomaly repair program, or acquire and generate a hardware anomaly repair program according to the device hardware fault information; and correspondingly, the device further includes the repair module 62 configured to perform hardware fault repair processing according to the hardware anomaly repair program.

Further, the anomaly state includes device software anomaly information; and correspondingly, the search module 53 is configured to acquire a software anomaly repair program, or generate a software anomaly repair program, or acquire and generate a software anomaly repair program according to the device software anomaly information; and correspondingly, the repair module 62 is further configured to perform software fault repair processing according to the software anomaly repair program.

Further, the help service category is an operation inquiry category; and correspondingly, the search module 53 is configured to search a database corresponding to the operation inquiry category, and acquire help knowledge information matching the information about the search intention; or generate operation step guiding information according to the help knowledge information.

The device described in this embodiment is configured to perform the method steps described in Embodiment 1, Embodiment 2, Embodiment 3, and Embodiment 4. A technical principle and generated technical effect of the device are similar to those of the method steps described in Embodiment 1, Embodiment 2, Embodiment 3, and Embodiment 4 and are not described herein again.

### Embodiment 7

As shown in FIG. 7, FIG. 7 is a schematic structural diagram of Embodiment 3 of a help processing device based on semantic recognition according to the present disclosure, which includes a transceiver 71, a semantic recognition processor 72, a searcher 73, and a fault repairer 74.

The transceiver 71 is configured to receive a search request entered by a user, where the search request includes information about a problem statement described in a natural language.

The semantic recognition processor 72 is configured to perform semantic recognition processing on the information about the problem statement, to obtain information about a search intention of the user.

The searcher 73 is configured to search a database using the information about the search intention as a search term, to obtain help content needed by the user.

Further, the semantic recognition processor 72 is configured to send the information about the problem statement to a network server, so that the network server performs semantic recognition processing on the information about the problem statement, to obtain the information about the search intention; and correspondingly, the transceiver 71 is configured to receive the information, which is fed back by the network server, about the search intention.

Further, the searcher 73 is configured to search, using the information about the search intention as the search term, a help database pre-stored in user equipment, to obtain the help content needed by the user, where help content is pre-stored in the help database; or send the search term to the network server, so that the network server searches a network database, to obtain the help content needed by the user, and receive the help content that is needed by the user and that is fed back by the network server.

Further, the semantic recognition processor 72 is configured to perform word segmentation processing on the information about the problem statement, to obtain a preprocessed search term; perform part-of-speech tagging and entity title identification processing on the preprocessed search term; and perform matching between the preprocessed search term after the part-of-speech tagging and entity title identification processing and a pre-stored semantic lexicon, and determine the information about the search intention of the user.

Further, the searcher 73 is configured to determine a help service category according to the information about the search intention; and search, using the information about the search intention as a keyword, a database corresponding to the help service category, to obtain the help content needed by the user.

Further, the searcher 73 is configured to perform machine learning on the information about the search intention, and determine the help service category; or perform a search using the information about the search intention as an index, to obtain the help service category corresponding to the information about the search intention.

Further, the searcher 73 is configured to compare a word included in the information about the search intention with words stored in a pre-established help service categorization base, and remove a word not related to the help service category or a redundant word; perform standardization processing on a word remaining in the information about the search intention, to obtain a standard search term of the help service categorization; and categorize the standard search term using a classification algorithm, and determine the help service category.

Further, the searcher 73 is configured to compare a word needed for the help service categorization with a synonym list stored in a pre-established standard lexicon, to obtain a corresponding standard search term of the help service categorization.

Further, the searcher 73 is configured to perform matching according to a word included in the information about the search intention and index words stored in all types of pre-established help service bases, and determine the help service category.

Further, the help service category is a user equipment repair or query category, and correspondingly, the searcher 73 is configured to search a device status information base corresponding to the user equipment repair or query category, and acquire a status detection report matching the information about the search intention; determine, according to the status detection report, whether a working state of the user equipment is abnormal; and if the working state of the user equipment is abnormal, acquire an anomaly repair program according to an anomaly state in the status detection report, or generate an anomaly repair program according to an anomaly state in the status detection report, or acquire and generate an anomaly repair program according to an anomaly state in the status detection report.

Further, the anomaly state includes device setting anomaly information; and correspondingly, the searcher 73 is configured to acquire a normal setting process, or generate a normal setting process, or acquire and generate a normal setting process according to the device setting anomaly information; and correspondingly, the device further includes a setting module configured to perform normal setting processing according to the normal setting process.

Further, the anomaly state includes device hardware fault information; and correspondingly, the searcher 73 is configured to acquire a hardware anomaly repair program, or generate a hardware anomaly repair program, or acquire and generate a hardware anomaly repair program according to the device hardware fault information; and correspondingly, the device further includes the fault repairer 74 configured to perform hardware fault repair processing according to the hardware anomaly repair program.

Further, the anomaly state includes device software anomaly information; and correspondingly, the searcher 73 is configured to acquire a software anomaly repair program, or generate a software anomaly repair program, or acquire and generate a software anomaly repair program according to the device software anomaly information; and correspondingly, the fault repairer 74 is further configured to perform software fault repair processing according to the software anomaly repair program.

Further, the help service category is an operation inquiry category; and correspondingly, the searcher 73 is configured to search a database corresponding to the operation inquiry category, and acquire help knowledge information matching the information about the search intention; or generate operation step guiding information according to the help knowledge information.

The device described in this embodiment is configured to perform the method steps described in Embodiment 1, Embodiment 2, Embodiment 3, and Embodiment 4. A technical principle and generated technical effect of the device are similar to those of the method steps described in Embodiment 1, Embodiment 2, Embodiment 3, and Embodiment 4 and are not described herein again.

It should be noted that, for ease of description, the foregoing method embodiments are described as a series of action combinations. However, a person skilled in the art should understand that the present disclosure is not limited to the described sequence of the actions, because some steps may be performed in another sequence or performed at the same time according to the present disclosure. In addition, a person skilled in the art should also understand that the embodiments described in this specification all belong to exemplary embodiments, and the involved actions and modules are not necessarily mandatory to the present disclosure.

A person of ordinary skill in the art may understand that all or some of the steps of the method embodiments may be implemented by a program instructing relevant hardware. The program may be stored in a computer readable storage medium. When the program runs, the steps of the method embodiments are performed. The foregoing storage medium includes any medium that can store program code, such as a read-only memory (ROM), a random access memory (RAM), a magnetic disk, or an optical disc.

Finally, it should be noted that the foregoing embodiments are merely intended for describing the technical solutions of the present disclosure but not for limiting the present disclosure. Although the present disclosure is described in detail with reference to the foregoing embodiments, persons of ordinary skill in the art should understand that they may still make modifications to the technical solutions described in the foregoing embodiments or make equivalent replacements to some technical features thereof, without departing from the spirit and scope of the technical solutions of the embodiments of the present disclosure.

What is claimed is:

1. A help processing method based on semantic recognition, comprising:
receiving a search request entered by a user, wherein the search request comprises information about a problem statement described in a natural language;
performing semantic recognition processing on the information about the problem statement in order to obtain information about a search intention of the user; and
searching a database using the information about the search intention as a search term in order to obtain help content needed by the user.

2. The method according to claim 1, wherein performing the semantic recognition processing on the information about the problem statement in order to obtain the information about the search intention of the user comprises:
sending the information about the problem statement to a network server, so that the network server performs semantic recognition processing on the information about the problem statement in order to obtain the information about the search intention; and
receiving the information about the search intention, which is fed back by the network server.

3. The method according to claim 1, wherein searching the database using the information about the search intention as the search term in order to obtain help content needed by the user comprises at least one of:
searching, using the information about the search intention as the search term, a help database pre-stored in user equipment in order to obtain the help content needed by the user, wherein the help content is pre-stored in the help database; and
sending the search term to a network server, so that the network server searches a network database in order to obtain the help content needed by the user, and receiving the help content that is needed by the user and that is fed back by the network server.

4. The method according to claim 1, wherein performing the semantic recognition processing on the information about the problem statement in order to obtain the information about the search intention comprises:
performing word segmentation processing on the information about the problem statement in order to obtain a preprocessed search term;
performing part-of-speech tagging and entity title identification processing on the preprocessed search term;
performing matching between the preprocessed search term after the part-of-speech tagging and entity title identification processing and a pre-stored semantic lexicon; and
determining the information about the search intention of the user.

5. The method according to claim 1, wherein searching the database using the information about the search intention as the search term in order to obtain help content needed by the user comprises:
determining a help service category according to the information about the search intention; and
searching, using the information about the search intention as a keyword, a database corresponding to the help service category in order to obtain the help content needed by the user.

6. The method according to claim 5, wherein determining the help service category according to the information about the search intention comprises:
performing machine learning on the information about the search intention, and determining the help service category; or
performing a search using the information about the search intention as an index in order to obtain the help service category corresponding to the information about the search intention.

7. The method according to claim 6, wherein performing the machine learning on the information about the search intention, and determining the help service category comprises:
comparing a word comprised in the information about the search intention with words stored in a pre-established help service categorization base, and removing a word not related to the help service category or a redundant word;
performing standardization processing on a word remaining in the information about the search intention in order to obtain a standard search term of the help service categorization; and
categorizing the standard search term using a classification algorithm, and determining the help service category.

8. The method according to claim 7, wherein performing the standardization processing on the word remaining in the information about the search intention in order to obtain the standard search term of the help service categorization comprises comparing a word needed for the help service categorization with a synonym list stored in a pre-established standard lexicon in order to obtain a corresponding standard search term of the help service categorization.

9. The method according to claim 6, wherein performing the search using the information about the search intention as the index in order to obtain the help service category corresponding to the information about the search intention comprises:
performing matching according to a word comprised in the information about the search intention and index words stored in all types of pre-established help service bases; and
determining the help service category.

10. The method according to claim 5, wherein the help service category is a user equipment repair or query category, and wherein searching the help database corresponding to the help service category according to the information about the search intention, to acquire the help content needed by the user comprises:
searching a device status information base corresponding to the user equipment repair or query category, and acquiring a status detection report matching the information about the search intention;
determining, according to the status detection report, whether a working state of user equipment is abnormal; and
at least one of acquiring and generating an anomaly repair program according to an anomaly state in the status detection report when the working state of the user equipment is abnormal.

11. The method according to claim 10, wherein the anomaly state comprises device setting anomaly information, wherein the at least one of acquiring and generating the anomaly repair program according to the anomaly state in the status detection report comprises at least one of acquiring and generating a normal setting process according to the device setting anomaly information; and wherein the method further comprises performing normal setting processing according to the normal setting process.

12. The method according to claim 10, wherein the anomaly state comprises device hardware fault information, wherein the at least one of acquiring and generating the anomaly repair program according to the anomaly state in the status detection report comprises at least one of acquiring and generating a hardware anomaly repair program according to the device hardware fault information, and wherein the method further comprises performing hardware fault repair processing according to the hardware anomaly repair program.

13. The method according to claim 10, wherein the anomaly state comprises device software anomaly information, wherein the at least one of acquiring and generating an anomaly repair program according to an anomaly state in the status detection report comprises at least one of acquiring and generating a software anomaly repair program according to the device software anomaly information, and wherein the method further comprises performing software fault repair processing according to the software anomaly repair program.

14. The method according to claim 5, wherein the help service category is an operation inquiry category, and wherein searching the help database corresponding to the help service category according to the information about the search intention, to acquire the help content needed by the user comprises at least one of:
searching a database corresponding to the operation inquiry category, and acquiring help knowledge information matching the information about the search intention; and
generating operation step guiding information according to the help knowledge information.

15. A help processing device based on semantic recognition, comprising:
a receiving module configured to receive a search request entered by a user, wherein the search request comprises information about a problem statement described in a natural language;
a semantic module configured to perform semantic recognition processing on the information about the problem statement in order to obtain information about a search intention of the user; and
a search module configured to search a database using the information about the search intention as a search term in order to obtain help content needed by the user.

16. The help processing device according to claim 15, wherein the semantic module is configured to send the information about the problem statement to a network server, so that the network server performs semantic recognition processing on the information about the problem statement in order to obtain the information about the search intention, and
wherein the receiving module is configured to receive the information about the search intention, which is fed back by the network server.

17. The help processing device according to claim 15, wherein the search module is configured to at least one of:
search, using the information about the search intention as the search term, a help database pre-stored in user equipment in order to obtain the help content needed by the user, wherein the help content is pre-stored in the help database; and
send the search term to a network server, so that the network server searches a network database in order to obtain the help content needed by the user, and receive the help content that is needed by the user and that is fed back by the network server.

18. The help processing device according to claim 15, wherein the semantic module is configured to:
perform word segmentation processing on the information about the problem statement in order to obtain a preprocessed search term;
perform part-of-speech tagging and entity title identification processing on the preprocessed search term;
perform matching between the preprocessed search term after the part-of-speech tagging and entity title identification processing and a pre-stored semantic lexicon; and
determine the information about the search intention of the user.

19. The help processing device according to claim 15, wherein the search module is configured to:
determine a help service category according to the information about the search intention; and
search, using the information about the search intention as a keyword, a database corresponding to the help service category in order to obtain the help content needed by the user.

20. The help processing device according to claim 19, wherein the search module is configured to at least one of:
perform machine learning on the information about the search intention, and determine the help service category; and
perform a search using the information about the search intention as an index in order to obtain the help service category corresponding to the information about the search intention.

21. The help processing device according to claim 20, wherein the search module is configured to:
compare a word comprised in the information about the search intention with words stored in a pre-established help service categorization base, and remove a word not related to the help service category or a redundant word;
perform standardization processing on a word remaining in the information about the search intention in order to obtain a standard search term of the help service categorization; and
categorize the standard search term using a classification algorithm, and determine the help service category.

22. The help processing device according to claim 21, wherein the search module is configured to compare a word needed for the help service categorization with a synonym list stored in a pre-established standard lexicon in order to obtain a corresponding standard search term of the help service categorization.

23. The help processing device according to claim 20, wherein the search module is configured to perform matching according to a word comprised in the information about the search intention and index words stored in all types of pre-established help service bases, and determine the help service category.

24. The help processing device according to claim 19, wherein the help service category is a user equipment repair or query category, and wherein the search module is configured to:
search a device status information base corresponding to the user equipment repair or query category, and acquire a status detection report matching the information about the search intention;
determine, according to the status detection report, whether a working state of user equipment is abnormal; and
at least one of acquire and generate an anomaly repair program according to an anomaly state in the status detection report when the working state of the user equipment is abnormal.

25. The help processing device according to claim 24, wherein the anomaly state comprises device setting anomaly information, wherein the search module is configured to at least one of acquire and generate a normal setting process according to the device setting anomaly information, and wherein the help processing device further comprises a setting module configured to perform normal setting processing according to the normal setting process.

26. The help processing device according to claim 24, wherein the anomaly state comprises device hardware fault information, wherein the search module is configured to at least one of acquire and generate a hardware anomaly repair program according to the device hardware fault information, and wherein the help processing device further comprises a repair module configured to perform hardware fault repair processing according to the hardware anomaly repair program.

27. The help processing device according to claim 24, wherein the anomaly state comprises device software anomaly information, wherein the search module is configured to at least one of acquire and generate a software anomaly repair program according to the device software anomaly information, and wherein the help processing device further comprises a repair module configured to perform software fault repair processing according to the software anomaly repair program.

28. The help processing device according to claim 19, wherein the help service category is an operation inquiry category, and wherein the search module is configured to at least one of:
search a database corresponding to the operation inquiry category, and acquire help knowledge information matching the information about the search intention; and
generate operation step guiding information according to the help knowledge information.
